(19) United States
(12) Patent Application Publication
(10) Pub. No.: US 2014/0023168 A1
(43) Pub. Date: Jan. 23, 2014

(54) CROSS-CORRELATION RECEIVER

(71) Applicant: Giuseppe Pasqualini, Vimercate (IT)

(72) Inventor: Giuseppe Pasqualini, Vimercate (IT)

(73) Assignee: ACCENT S.P.A., Vimercate, MB (IT)

(21) Appl. No.: 13/977,882

(22) PCT Filed: Dec. 28, 2011
(86) PCT No.: PCT/EP2011/074159

§ 371 Date: Sep. 30, 2013

Related U.S. Application Data
(60) Provisional application No. 61/427,911, filed on Dec. 29, 2010.

(30) Foreign Application Priority Data
Dec. 29, 2010 (IT) MI2010A002436

(51) Int. Cl. H04L 7/04

(52) U.S. Cl. CPC H04L 7/042
USPC 375/343

(57) ABSTRACT

An embodiment of a receiver is proposed. The receiver includes a buffer element for receiving an input signal continuously, synchronization means for synchronizing the input signal by monitoring a buffer signal corresponding to the input signal within the buffer element at a corresponding monitoring time for determining a complete reception of at least one preamble signal within the buffer signal at a reception time, and by synchronizing the input signal according to the detection of the complete reception of the at least one preamble signal, and extraction means including at least one operative block configurable in an extraction phase for extracting a data signal associated with the at least one preamble signal from the input signal. In an embodiment, the synchronization means shares said at least one operative block with the extraction means; said at least one operative block is configurable in a synchronization phase for synchronizing the input signal. The operative block includes correlation means configurable in the synchronization phase for calculating at each monitoring time a correlation function between the buffer signal and a reference signal corresponding to the preamble signal, detection means configurable in the synchronization phase for detecting a partial reception of a significant portion of the preamble signal at a partial reception time according to the correlation function, and prediction means configurable in the synchronization phase for predicting the reception time according to the partial reception time.

### PRIORITY CLAIM

The present application is a national phase application filed pursuant to 35 USC §371 of International Patent Application Serial No. PCT/EP2011/074159, filed Dec. 28, 2011; which further claims the benefit of the U.S. Provisional Patent Application Ser. No. 61/427,911 filed Dec. 29, 2010, now expired; and further claims benefit of Italian Patent Application No. MI2010A002436, filed Dec. 29, 2010, all of the foregoing applications are incorporated herein by reference in their entireties

### TECHNICAL FIELD

One or more embodiments generally relate to communication systems. More specifically, one or more embodiments relate to synchronization techniques for communication systems.

### SUMMARY

Communication systems, such as narrow-band communication systems, are widely used in many applications requiring that signals modulated according to different frequencies should be transmitted simultaneously within a predefined band of transmission frequencies.

For example, a widely used class of narrow-band communication systems is represented by OFDM (Orthogonal Frequency Division Multiplexing) systems. In general, the OFDM systems implement a multi-carrier communication of a stream of data (typically of the digital type, such as binary digits or bits) being provided, for example, by one or more apparatuses upstream the OFDM systems.

In particular, the OFDM systems typically include a transmission block for receiving the data stream and transmitting corresponding symbols (obtained by distributing the data stream into data groups, and modulating each data group on a corresponding carrier, being orthogonal with respect to the other carriers), a propagation channel for receiving and propagating the symbols, and a receiver for receiving the symbols propagated through the propagation channel and providing the data stream (obtained by carrying out, on the received symbols, reverse operations with respect to those performed by the transmitter).

The distribution and modulation of the data flow on many carriers allows, in principle, greatly reducing undesired interference phenomena between adjacent symbols (inter-symbol interference) to which other communications systems (for example, those based on single carrier modulation) are usually affected. The orthogonality of the carriers, instead, allows ensuring a spectral efficiency comparable to that of single carrier transmission, ideally without interference phenomena among carriers (inter-carrier interference) even in the case that they are partly overlapped to each other in frequency.

However, OFDM systems have drawbacks that may preclude a wider use thereof in some applications that need high performance and reliability.

In particular, one of such drawbacks relates to a misalignment effect of the symbols being input to the receiver with respect to an “acquisition window” (i.e., a time interval wherein the receiver completely acquires a predetermined number of symbols only, for example, one symbol at a time), which ideally should be in an alignment condition with the received symbols for completely acquiring them and hence properly processing them.

The latter condition requires that the receiver should implement a symbol synchronization procedure within it, so as to avoid that the symbol misalignment with respect to the acquisition window would involve inter-symbol interference and/or inter-carrier interference phenomena that may considerably degrade performance of the OFDM system.

For example, in a widely used synchronization procedure, the transmission block sends, within a pre-defined time interval, one or more redundant symbols (or preamble symbols) of known duration (preamble time) before sending each symbol that contains the corresponding data group (or data symbol); at this point, the synchronization procedure identifies (for example, by estimates based on correlation and/or maximum likelihood criteria) the preamble symbol, discards samples included within the preamble time, and aligns the acquisition window of the receiver to the data symbol (acquisition window being properly positioned).

In the state of the art different synchronization techniques exist that are able to implement the synchronization procedure of above. For example, the document WO 2009/149429 A2, which is incorporated by reference, shows a symbol synchronization technique that may be used in a communication technology of PLC (Power Line Communication) type; in particular, such synchronization technique is based on an identification of a sign of each sample of the preamble symbol, storage of all the signs in a corresponding sign array, correlation estimation of the sign array, and synchronization of the acquisition window according to the correlation estimation.

However, such solution is not fully satisfactory, since (analogously to other known procedures) it is based on a correlation estimation, which hence may not have a high accuracy; moreover, it requires a relatively substantial number of additional functional blocks implemented within the receiver, which results in a greater complexity thereof, and thus higher costs.

In its general terms, one or more embodiments are based on the idea of exploiting already existing functional blocks.

In particular, one or more embodiments are set out in the independent claims, with advantageous features of the same one or more embodiments that are indicated in the dependent claims, whose wording is enclosed herein verbatim by reference (with any advantageous feature being provided with reference to a specific embodiment that applies mutatis mutandis to any other aspect thereof).

More specifically, an embodiment is a receiver (e.g., an OFDM receiver). The receiver includes a buffer element for receiving an input signal continuously (including, for example, data symbols and preamble symbols). Synchronization means is provided for synchronizing the input signal; such result is obtained by monitoring a buffer signal corresponding to the input signal within the buffer element at a corresponding monitoring time for determining a complete reception of at least one preamble signal within the buffer signal at a reception time, and by synchronizing the input signal according to the detection of the complete reception of the at least one preamble signal. The receiver also includes extraction means, which includes at least one operative block configurable in an extraction phase for extracting a data signal associated with the at least one preamble signal from the input signal. In an embodiment, the synchronization means shares said at least one operative block with the extraction means; said at least one operative block is configurable in a synchronization phase for synchronizing the input signal. The operative block includes correlation means configurable in the synchronization phase for calculating, at each monitoring time, a correlation function (for example a cross-correlation function) between the buffer signal and a reference signal corresponding to the preamble signal. The operative block further includes detection means configurable in the synchronization phase for detecting a partial reception of a significant portion of the preamble signal at a partial reception time according to the correlation function. The operative block also includes prediction means configurable in the synchronization phase for predicting the reception time according to the partial reception time.

### BRIEF DESCRIPTION OF THE DRAWINGS

One or more embodiments, as well as features and the advantages thereof, will be best understood with reference to the following detailed description, given purely by way of a non-restrictive indication, to be read in conjunction with the accompanying drawings (wherein corresponding elements are denoted with equal or similar references, and their explanation is not repeated for the sake of exposition brevity). In this respect, it is expressly understood that the figures are not necessarily drawn to scale (with some details that may be exaggerated and/or simplified) and that, unless otherwise indicated, they are simply used to conceptually illustrate the described structures and procedures. In particular:

FIG. 1 schematically shows a communication system known in the state of the art wherein one or more embodiments may be applied.

FIG. 2 schematically shows a communication system according to an embodiment.

FIGS. 3A-3D schematically show time diagrams of some exemplary phases of a synchronization procedure according to an embodiment.

### DETAILED DESCRIPTION

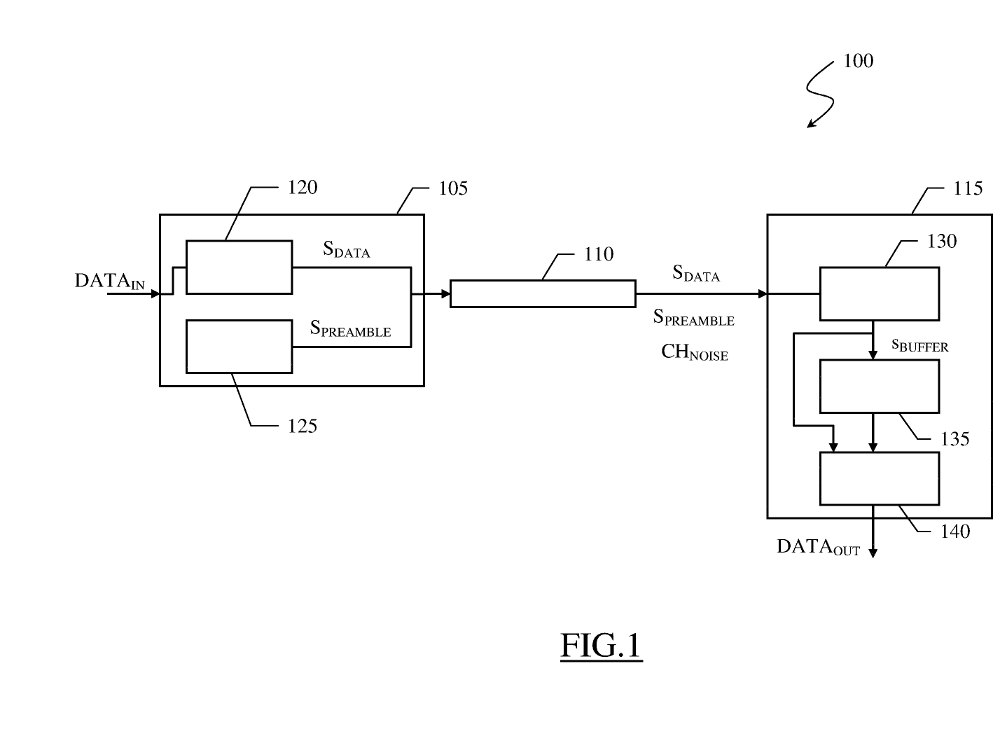

With particular reference to FIG. 1, it schematically shows a generic communication system wherein one or more embodiments may be applied. More specifically, the illustrated communication system implements a narrowband communication system (i.e., wherein the signals transmitted over a propagation channel have a band lower than a coherence band of the propagation channel), such as for example an OFDM communication system or OFDM system, 100.

The OFDM system 100 generally includes a transmitter 105 for receiving an input data stream DATA_{IN} (typically digital data, such as binary digits or bits) and transmitting corresponding symbols, a propagation channel 110 for receiving and propagating the symbols, and a receiver 115 for receiving the symbols propagated over the propagation channel 110 and providing an output data stream DATA_{OUT} that should be equal to the data stream DATA_{IN}.

For the sake of description simplicity, the transmitter 105, the propagation channel 110 and the receiver 115 of the OFDM system 100 are represented as generic blocks (as having well known structure and operation), and will now be described by mentioning only structural and/or functional aspects being relevant for understanding the concepts disclosed herein.

In this respect, the transmitter 105 includes a data symbolization block 120 and a preamble block 125. More particularly, the data symbolization block 120 receives the data stream DATA_{IN} and executes a sequence of operations on the latter (e.g., encoding, modulation, conversion and transformation, although not necessarily in such order); at the end of such operations, the data stream DATA_{IN} is divided into data groups modulated on corresponding carriers being orthogonal to each other (typically in high numbers, such as approximately between 10 and 50000, depending on the application) so as to form a sequence of data symbols S_{DATA} (i.e., each symbol S_{DATA} includes a respective data group of the data stream DATA_{IN} modulated on a corresponding carrier being orthogonal with respect to any other carrier). The preamble block 125, instead, associates, to pre-defined groups of symbols S_{DATA}, redundant symbols, or preamble symbols S_{PREAMBLE}, which, as will be explained shortly, are usually used by the receiver 115 for synchronization purposes. In this way, the transmitter 105 transmits the symbols S_{DATA} to the propagation channel 110 properly spaced out by the symbols S_{PREAMBLE} (and wherein number and interval of the symbols S_{PREAMBLE} vary according to specific transmission protocols implemented by the transmitter 105, to which the present disclosure is not limited).

The propagation channel 110 receives the symbols S_{DATA},S_{PREAMBLE} and allows a correct propagation thereof from the transmitter 105 to the receiver 115; this is typically obtained by performing, at propagation start, a digital-to-analog conversion of the symbols S_{DATA},S_{PREAMBLE} and subsequent up-conversion thereof, and, at propagation end, a base-band re-conversion (down-conversion) and subsequent analog-to-digital conversion.

In this way, the receiver 115 receives the symbols S_{DATA},S_{PREAMBLE} from the propagation channel 110. However, as it is visible in the figure, the symbols S_{DATA},S_{PREAMBLE} being input to the receiver 115 may be typically associated with noise contributions CH_{NOISE} (for example, being originated within the propagation channel 110 or collected by it, or deriving from residual symbols); for this reason, in the following the symbols S_{DATA},S_{PREAMBLE}, and the noisy contributions CH_{NOISE} will be referred to as input signal S_{DATA},S_{PREAMBLE},CH_{NOISE} (for the receiver 115).

The receiver 115 includes a buffer element 130 for receiving the signal S_{DATA},S_{PREAMBLE},CH_{NOISE} continuously; in this respect, since the buffer element 130 has a limited buffer capacity (i.e., it may contain only a predefined amount of the signal S_{DATA},S_{PREAMBLE},CH_{NOISE}), at each time instant the buffer element 130 has a corresponding portion of the signal S_{DATA},S_{PREAMBLE},CH_{NOISE} within it, hereinafter referred to as buffer signal s_{BUFFER} (i.e., the signal s_{BUFFER} is the portion of the signal S_{DATA},S_{PREAMBLE},CH_{NOISE} within the buffer element 130 at a given time instant).

The receiver 115 also includes a synchronization block 135 for receiving the signal s_{BUFFER} and performing synchronization operations according to the received signal s_{BUFFER}, and a data block 140 coupled to the synchronization block 135 and to the buffer element 130. In particular, the data block 140 receives (upon proper enabling by the synchronization block 135) the symbols S_{DATA} from the buffer element 130, starting from which, through reverse operations with respect to those of the data symbolization block 120 of the transmitter 105, it provides the data stream DATA_{OUT} (in this respect, it is noted that the data block 140 acts as an extraction element of the data stream DATA_{OUT} from the symbols S_{DATA}).

More in particular, the synchronization block 135 allows synchronizing (or time aligning) an acquisition window of the data block 140 to a predetermined number of symbols S_{DATA} (for example, a single symbol S_{DATA}, as will be assumed hereinafter for the sake of description simplicity) according to a detection of one or more symbols S_{PREAMBLE} associated therewith (a single symbol S_{PREAMBLE}, as will be exemplarily but not limitatively assumed hereinafter); in order to achieve this, the synchronization block 135, upon detection of the symbol S_{PREAMBLE} within the buffer element 130, provides an appropriate signal to the data block 140 on the basis of which the data block 140 aligns the acquisition window to the symbol S_{DATA}. In this way, the data block 140, being synchronized to the symbol S_{DATA}, is able to output the data stream DATA_{OUT} with effects of inter-symbol interference and inter-carrier interference that depend on quality and performance of a synchronization procedure implemented by the synchronization block 135.

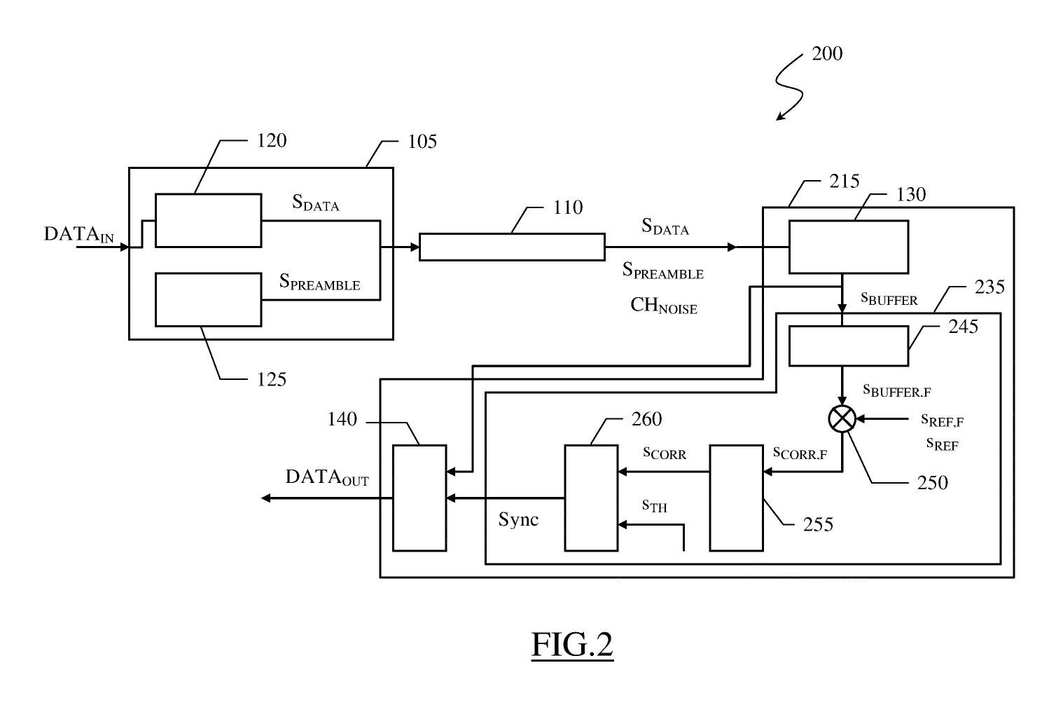

Turning now to FIG. 2, it schematically shows a communication system according to an embodiment. The communication system implements an OFDM system 200 similar to the previous one, i.e., including the transmitter 105, the propagation channel 110, and a receiver 215.

More in particular, the receiver 215 includes the buffer element 130 containing the signal s_{BUFFER}, the data block 140 for providing the data stream DATA_{OUT}, and a synchronization block 235 for receiving the signal s_{BUFFER} and providing a corresponding synchronization signal Sync to the data block 140.

The synchronization block 235 includes a transformation block 245 for receiving the signal s_{BUFFER} (that is, a time-domain signal) and providing a corresponding transformed buffer signal s_{BUFFER,F} obtained from the signal s_{BUFFER} on which a direct Fourier transform operation has been performed (i.e., the signal s_{BUFFER,F} defines a frequency-domain representation of the signal s_{BUFFER}).

The synchronization block 235 also includes a complex multiplication element 250 for being input the signal S_{BUFFER,F} and a frequency-domain reference signal S_{REF,F} (for example, the conjugate of the direct Fourier transform of a corresponding time-domain reference signal S_{REF}), and providing a frequency-domain correlation signal S_{CORR,F} obtained by a complex multiplication between the signal s_{BUFFER,F} and the signal S_{REF,F}.

The synchronization block 235 also includes an anti-transformation block 255 for receiving the signal S_{CORR,F} and providing a time-domain correlation signal s_{CORR} obtained from the signal s_{CORR,F} on which a Fourier anti-transformation (or inverse Fourier transform) has been performed.

Therefore, it is noted that since, as it is known, the frequency-domain multiplication (in the case at issue, the complex multiplication between the signal s_{BUFFER,F} and the signal s_{REF,F}) corresponds to a time-domain correlation operation, the signal s_{CORR} represents, as a matter of fact, the correlation (or cross-correlation) function between the signal s_{BUFFER} and the signal s_{REF}. Moreover, for known properties of the (direct and inverse) Fourier transform, the signal s_{CORR,F} is indicative of a phase-shifting parameter between the signal s_{BUFFER} and the signal S_{REF,F}; according to well-known principles, such phase shifting parameter may be conveniently used, for example, for regulating in feedback a phase shifting of components (not shown) of the data block 140 and, additionally or alternatively, as a discrimination element within an OFDM system wherein the transmitter 105 implements a different transmission protocol (as will be explained in more detail in the following).

The synchronization block 235 also includes a detection block 260, which receives the signal s_{CORR} and a threshold value s_{TH}, calculates a peak value V_{PEAK} of the signal s_{CORR}, and provides the signal Sync to the data block 140 according to a comparison between the threshold value s_{TH} and the peak value V_{PEAK} (with the signal Sync that is used by the data block 140 for the alignment of the acquisition window to the symbol S_{DATA}).

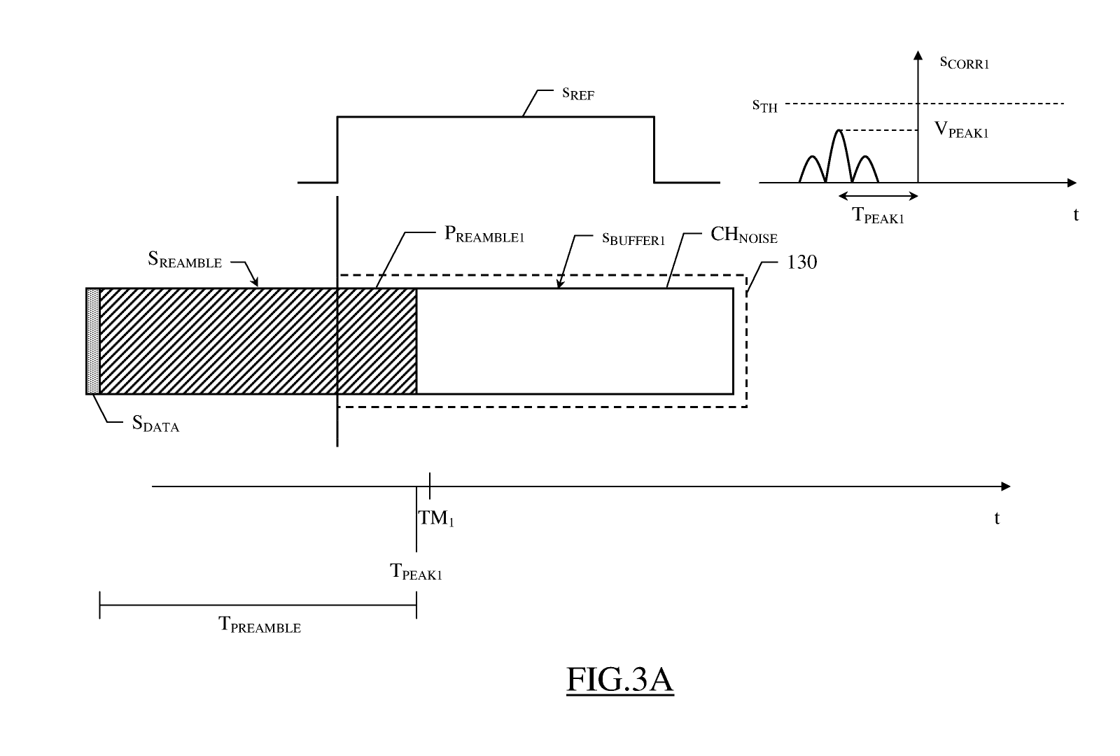

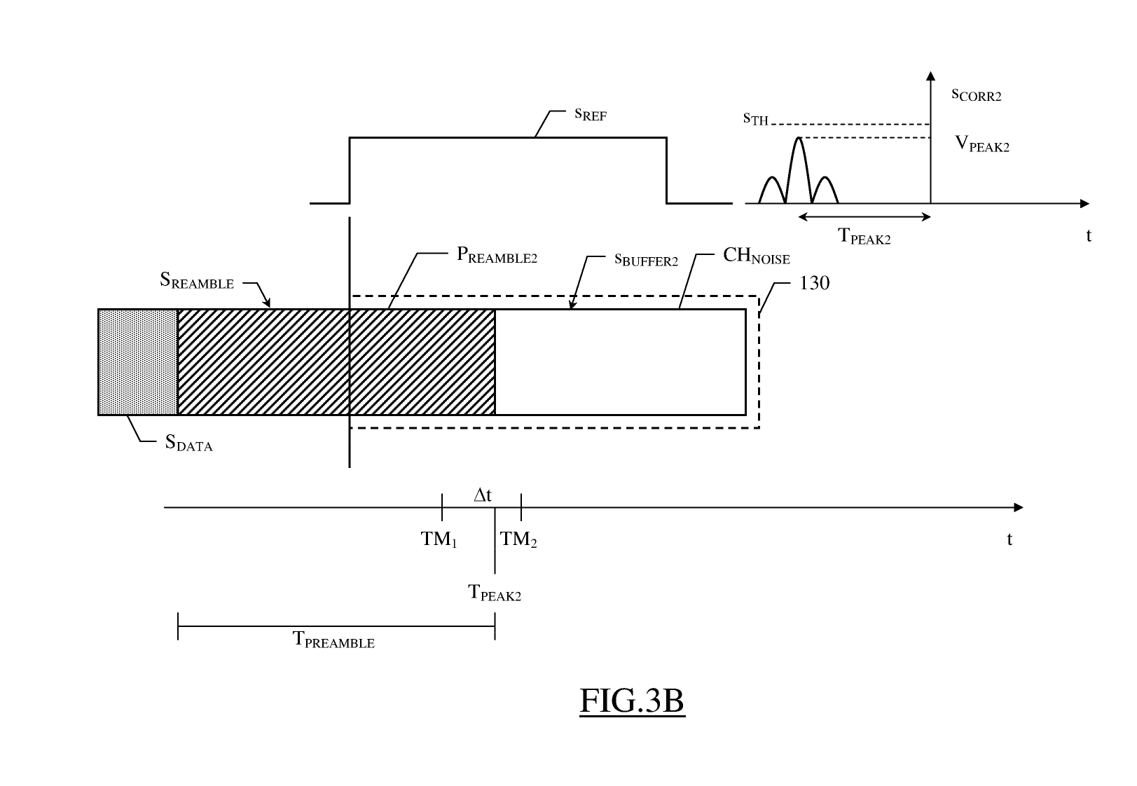

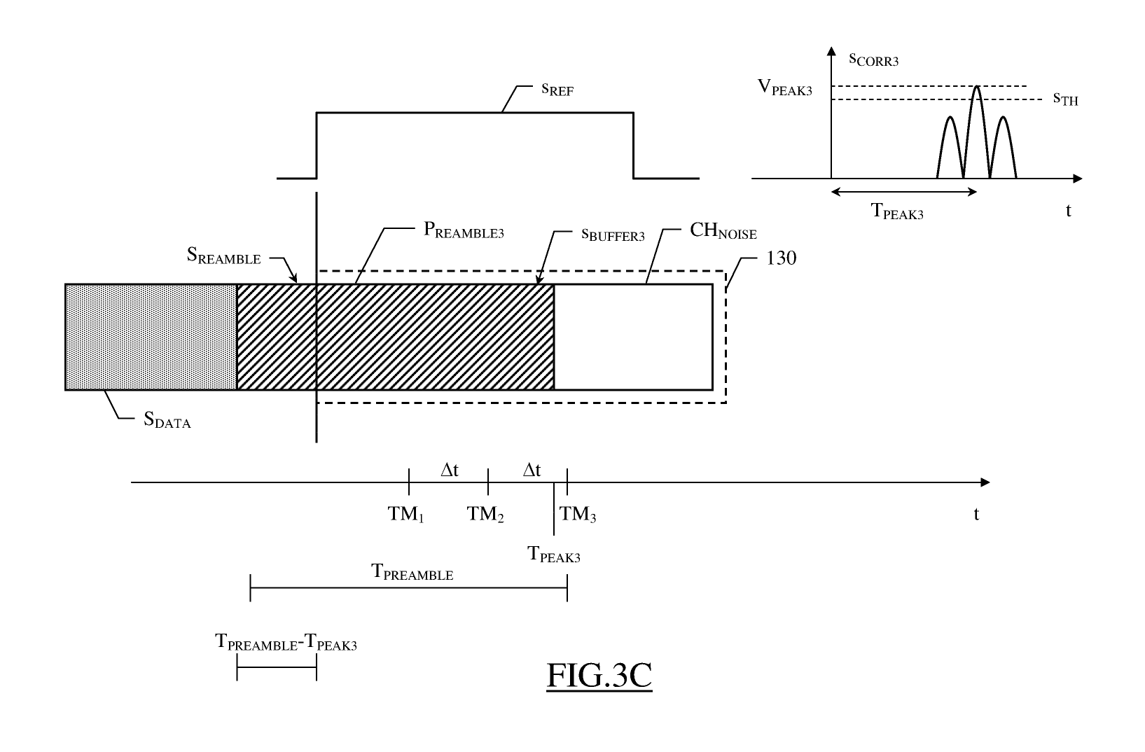

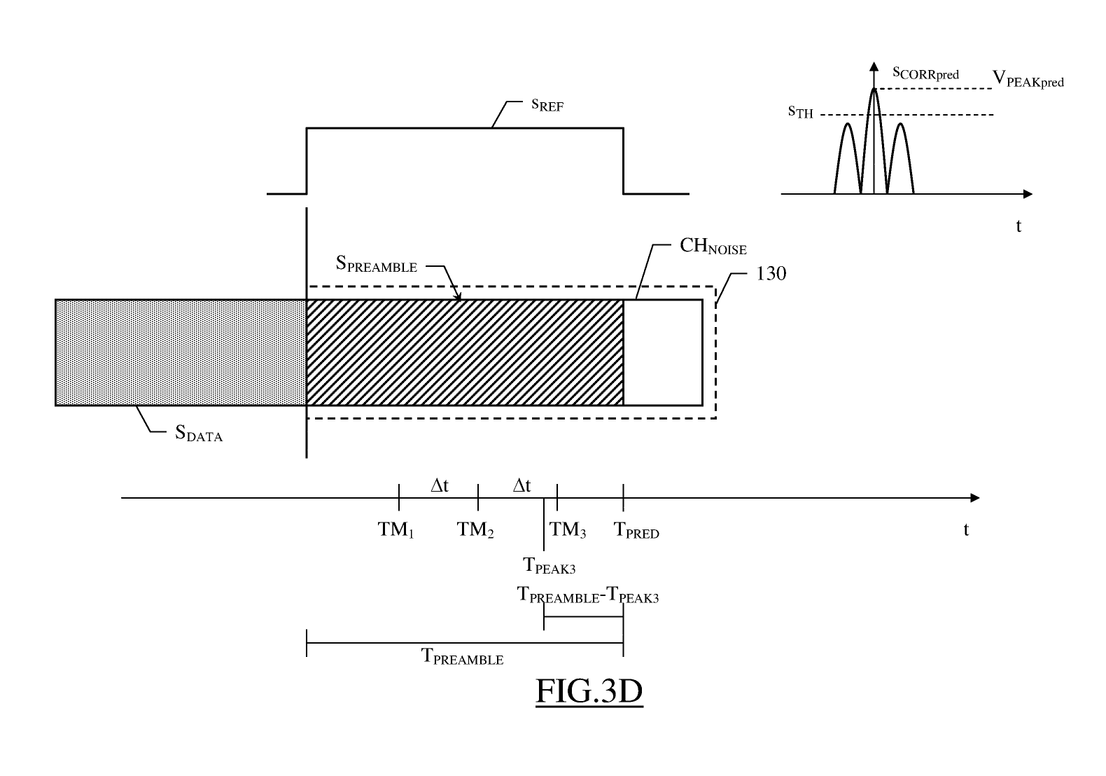

The operation of the receiver 215 may be summarized as follows (with reference to FIG. 2 jointly to FIGS. 3A-3D, which schematically show time diagrams of some exemplary steps of a synchronization procedure according to an embodiment).

In general, the synchronization procedure is such that the synchronization block 235, properly temporised by temporisation blocks (not shown for the sake of simplicity), monitors, at properly chosen monitoring instants TM, the signal s_{BUFFER} in order to detect the presence of a symbol S_{PREAMBLE} within the latter (indicative that a symbol S_{DATA} is going to be received, or is being received, within the buffer element 130), and performs the synchronization of the acquisition window even before the symbol S_{PREAMBLE} has been completely received within the buffer 130 element.

In particular, let be supposed that, as schematically illustrated in FIG. 3A, at a monitoring instant TM₁ a signal s_{BUFFER1} (i.e., the signal s_{BUFFER} present within the buffer element 130 at the instant TM₁) includes a portion P_{PREAMBLE1} of the symbol S_{PREAMBLE} (represented in the figure by a rectangle filled with oblique lines for the sake of simplicity), and that remaining portions of the buffer element 130 are occupied by noise contributions CH_{NOISE} (for example, residues of previous transmissions).

In such condition, at the instant TM₁, the synchronization block 235 performs the correlation operation (by the transformation block 245, the complex multiplication element 250 and the anti-transformation block 255) between the signal s_{BUFFER1} and the signal S_{REF} (exemplary but not limitatively shown as a rectangular signal for the sake of simplicity) to obtain a corresponding correlation signal S_{CORR,1} (shown in the figure with a generic trend merely illustrative).

At this point, the detection block 260 calculates a peak value V_{PEAK1} of the signal S_{CORR,1} (temporally positioned at a corresponding peak time T_{PEAK1}—generally not coincident, as in the example at issue, with the instant TM₁) and compares it to the threshold value s_{TH}. If, as in the example in the figure, the peak value of the signal S_{CORR,1} is lower than the threshold value s_{TH} (indicating that the portion P_{PREAMBLE1} being received within the buffer element 130 has not yet been recognized as a symbol S_{PREAMBLE}), no further operation is performed by the synchronization block 235.

Similarly, with reference to FIG. 3B, at a monitoring instant TM₂ (for example, after a predefined time interval Δt subsequent to the instant TM₁) a signal s_{BUFFER2} includes a portion P_{PREAMBLE2} of the symbol S_{PREAMBLE} greater than the portion P_{PREAMBLE1}, but the correlation signal S_{CORR2} has a peak value V_{PEAK2} that is still lower than the threshold value s_{TH} (and with the value V_{PEAK2} placed, for example, at a peak instant T_{PEAK2} different from the instant TM₂); also in this case, the portion P_{PREAMBLE2} in the buffer element 130 is not recognized as a symbol S_{PREAMBLE}.

Instead, in the situation described in FIG. 30, at a monitoring instant TM₃ (e.g., temporally displaced from the instant TM₂ by the same interval Δt) a signal s_{BUFFER3} includes a portion P_{PREAMBLE3} such that the correlation signal S_{CORR3} has a peak value V_{PEAK3} that exceeds the threshold value s_{TH}. In this case, the synchronization block 235 is in a prediction condition for which the monitoring instant TM₃ defines a partial reception instant wherein the portion P_{PREAMBLE3} is reasonably interpreted as a symbol S_{PREAMBLE}, although no symbol S_{PREAMBLE} has been received within the buffer element 130 yet (but only a significant portion thereof, defined by the threshold value s_{TH}). Once the prediction condition has been detected, the detection block 260 extracts a peak instant T_{PEAK3} from the signal S_{CORR,3} at which the value V_{PEAK3} is placed and provides the signal Sync to the data block 140 according to the calculated value of the instant T_{PEAK3}.

In particular, the signal Sync includes information relating to a prediction time instant T_{PRED} wherein the symbol S_{PREAMBLE} is supposed to be fully received within the buffer element 130. More specifically, since the instant T_{PEAK} within the signal s_{CORR} always corresponds, for operative definition of the correlation operation, to the position of a first sample of the symbol S_{PREAMBLE} received within the buffer element 130, the instant T_{PRED} may be calculated as follows:

T_{PRED}=T_{PEAK3}+(T_{PREAMBLE}−T_{PEAK3})

wherein the expression (T_{PREAMBLE}−T_{PEAK3}) corresponds, in time, to a residual portion of the symbol S_{PREAMBLE}.

In general, the instant T_{PRED} may be calculated as follows:

T_{PRED}=T_{PEAKi}+(T_{PREAMBLE}−T_{PEAKi})

wherein the term T_{PEAKi} denotes the instant relative to the value V_{PEAKi} of the signal S_{CORRi} calculated at the instant TMᵢ that defines the partial reception time (TM₃ in the example at issue).

The described embodiment is advantageous as it allows providing the signal Sync to the data block 140 before the symbol S_{PREAMBLE} is completely received within the buffer element 130, with possible saving in terms of processing time required in some applications and/or implementations. Moreover, the described embodiment provides a stable and safe synchronization signal, as the prediction of the arrival of the symbol S_{PREAMBLE} is obtained by physically performing the correlation operation, and not an estimate thereof.

In addition, it is noted that the described embodiment is easy and inexpensive to implement, as it generally allows exploiting resources already present within the OFDM system 200; in particular, since the synchronization block 235 performs operations that may all be executed by functional blocks that typically are common to many OFDM receivers (such as FFT, IFFT operating blocks, peak detectors, and comparators usually present within the data block 140), the described synchronization procedure may be performed also without using auxiliary resources; in this respect, in fact, it is noted that during the known synchronization procedures (such as the one mentioned in the introductory part of the present description), the data block 140 is usually unused, since it is not necessary (and therefore it may be used for implementing the described synchronization procedure without that this involves processing delays or additional costs for the OFDM system). In this way, an embodiment allows using, in a synchronization phase (intended to synchronize the acquisition window to the symbols S_{DATA}), the operative blocks (FFT, IFFT, peak detectors and comparators) being necessary for implementing the above-described synchronization procedure, and, in an extraction phase (following the synchronization phase, and intended to extract the data stream DATA_{OUT} from the symbols S_{DATA}), the same operative blocks (but configured differently); in particular, the operative blocks 245,250,255,260 are shared by the data block 140 and the synchronization block 235 (although in FIG. 2 they are shown separated for better illustrating the logical operation thereof), with consequent saving in terms of resources needed to implement the receiver.

Conveniently, upon detection of the prediction condition, the synchronization block 235 performs a new correlation operation, but this time at the instant T_{PRED}, as shown in FIG. 3D.

In this way, the resulting correlation signal S_{CORRpred} may be used as a signal for checking prediction correctness (for example, if the detection block 260 detects that the peak value of the signal S_{CORRpred} is exactly at the instant T_{PRED}, the prediction may be considered correct, otherwise it is possible to generate a regulation signal, not shown, that regulates the signal Sync accordingly).

In addition, the signal S_{CORRpred} may also be used for regulating a gain of the receiver 215; in fact, since the symbols S_{DATA},S_{PREAMBLE} received by the receiver 215 typically may have an inadequate amplitude swing, the gain of the receiver 215 may be regulated (for example, again by the data block 140) according to a power information of the received symbol S_{PREAMBLE} (with such power information that is comprised, as it is known, within the signal S_{CORRpred}).

The described embodiment is further advantageous as it allows obtaining a very precise synchronization signal, even in case of a not wholly accurate prediction of the instant T_{PRED}.

It is noted that the described embodiment is independent of the number and type of preamble signals S_{PREAMBLE} used by the transmitter 105 (that depend on the transmission protocol implemented by the latter). For example, a widely used transmission protocol, not shown in any figure, associates, to a determined group of symbols S_{DATA}, a succession of first preamble signals equal to each other (and, for example, each one equal to the signal S_{PREAMBLE}), and one (or more) second preamble signals different from the first preamble signals. In such situation, the described embodiment is equally applicable, as it is possible to discriminate (e.g., by exploiting the detection block 260) the second preamble signal from the first preamble signals according to a comparison between the phase-shifting parameter of the second preamble signal and the phase-shifting parameter of the first preamble signals.

Naturally, in order to satisfy local and specific requirements, a person skilled in the art may apply to the one or more embodiments described above many logical and/or physical modifications and alterations. More specifically, although one or more embodiments have been described with a certain degree of particularity, it is to be understood that various omissions, substitutions and changes in the form and details as well as other embodiments are possible. In particular, different embodiments may even be practiced without the specific details (such as the numeric examples) set forth in the preceding description for providing a more thorough understanding thereof; on the contrary, well known features may have been omitted or simplified in order not to obscure the description with unnecessary particulars. Moreover, it is expressly intended that specific elements and/or method steps described in connection with any disclosed embodiment may be incorporated in any other embodiment as a matter of general design choice.

For example, analogous considerations apply if the receiver has a different structure or includes equivalent components, or it has other operating features. In any case, any component thereof may be separated into several elements, or two or more components may be combined into a single element; moreover, each component may be replicated for supporting the execution of the corresponding operations in parallel. It is also to be noted that any interaction between different components generally does not need to be continuous (unless otherwise indicated), and it may be both direct and indirect through one or more intermediaries. For example, the receiver may include dedicated temporization blocks for temporizing the synchronization block, or the synchronization block may be managed entirely by a shared temporization block.

Moreover, although in the present disclosure explicit reference has been made to narrow-band communication systems, this is not to be construed limitatively. In fact, the described receiver lends itself to be applied to any other communication systems, such as wireless (e.g., radio frequency, microwave, infrared) communication systems for implementing point-to-point communications, point-to-multipoint communications, broadcasting, cellular networks, or PLC (Power Line Communication) communication systems.

The reference signal is not limitative for the present disclosure, since it may take any suitable trend, also depending on architectures of functional blocks implemented within the receiver; in this respect, it is to be noted that the reference signal may be already available within the receiver, generated specifically within it, or supplied from the outside.

The detection of the prediction condition (i.e., of the partial reception instant), which also depends on the chosen threshold value, may be conveniently associated with appropriate known prediction algorithms; in such way, it is hence possible to shorten the times required for the prediction, and/or use a lower threshold value.

Moreover, the frequency-domain buffer signal and the frequency-domain reference signal may be obtained in any other way (i.e., not by an FTT operator, but, for example, by using another algorithm implementing the Fourier transform); in addition, the frequency-domain buffer signal and the frequency-domain reference signal may be obtained in different ways from each other starting from the respective time-domain signals (for example, the frequency-domain buffer signal may be obtained by FFT operator, whereas the frequency-domain reference signal may be obtained by a different algorithm, or directly supplied from the outside, or vice versa).

In general, the transmission protocol implemented by the transmitter is not limitative for the present disclosure; for example, it is possible to provide for transmission protocols wherein one or more preamble symbols are associated with a single data symbol, or protocols that provide for the use of preamble symbols of different shape and duration for each data symbol (or, alternatively, for each group of data symbols). Moreover, the preamble symbol is not limitative for the present disclosure, as it may include replicated portions of one or more data symbols, or signals being properly generated within the transmitter or provided thereto from an external source.

Moreover, it is to be readily understood that the receiver may be part of the design of an integrated circuit. The design may also be created in a hardware description language; moreover, if the designer does not manufacture the integrated circuit or the masks, the design may be transmitted by physical means to others. In any case, the resulting integrated circuit may be distributed by its manufacturer in raw wafer form, as a bare die, or in packages. Moreover, the proposed structure may be integrated with other circuits in the same chip, or it may be mounted in intermediate products (such as mother boards) and coupled with one or more other chips (such as a processor). In any case, the integrated circuit is suitable to be used in complex systems (such as automotive applications).

In addition, an embodiment lends itself to be implemented through an equivalent method (by using similar steps, removing some steps being not essential, or adding further optional steps); moreover, the steps may be performed in different order, concurrently or in an interleaved way (at least partly). In this respect, the steps of the described synchronization procedure may be in any number, and depending on a number of monitoring instants necessary to the synchronization block for associating a given preamble portion to the preamble symbol; moreover, also the time interval between subsequent monitoring instants (previous to the partial detection condition) may be any ones, and regulated, for example, according to a desired maximum number of monitoring instants.

Alternatively, an embodiment may also be implemented without the technique of prediction of the reception instant of the preamble symbol (but simply by sharing the operative blocks between the synchronization block and the data block), with the sharing of only some functional blocks, or at the limit without the sharing of any operative block (but simply with the prediction technique of the reception instant of the preamble symbol).

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A receiver comprising
a buffer element for receiving an input signal continuously,
synchronization means or synchronizing the input signal by monitoring a buffer signal corresponding to the input signal within the buffer element at a corresponding monitoring time for determining a complete reception of at least one preamble signal the buffer signal at a reception time, and by synchronizing the input signal according to the detection of the complete reception of the at least one preamble signal, and
extraction means comprising at least one operative block configurable in an extraction phase for extracting a data signal associated with the at least one preamble signal from the input signal,
wherein the synchronization means shares said at least one operative block with the extraction means, said at least one operative block being configurable in a synchronization phase for synchronizing the input signal, the operative block comprising:
correlation means configurable in the synchronization phase for calculating at each monitoring time a correlation function between the buffer signal and a reference signal corresponding to the preamble signal,
detection means configurable in the synchronization phase for detecting a partial reception of a significant portion of the preamble signal at a partial reception time according to the correlation function, and
prediction means configurable in the synchronization phase for predicting the reception time according to the partial reception time.

2. The receiver according to claim 1, wherein the correlation means comprises means for calculating a frequency-domain correlation function between the buffer signal and the reference signal if at each monitoring time.

3. The receiver according to claim 2, wherein said means for calculating the correlation function comprises:
transformation means for calculating a frequency-domain buffer signal and a frequency-domain reference signal by an operation of Fourier transform of the buffer signal and of the reference signal, respectively, and
complex multiplication means for obtaining the frequency-domain correlation function by a complex multiplication between the frequency-domain buffer signal and the frequency-domain reference signal.

4. The receiver according to claim 1, wherein said detection means comprises:
means for calculating a peak value of the correlation function, and
means for comparing the peak value with a threshold value.

5. The receiver according to claim 4, wherein said prediction means comprises:
means for calculating the reception time by combining a peak time corresponding to the peak value of the correlation function, and an estimated duration of the preamble signal.

6. The receiver according to claim 5, wherein the correlation means is further configurable for:
calculating a further correlation function between the buffer signal at the reception time and the reference signal.

7. The receiver according to claim 6, further comprising:
means for controlling a receiver gain according to the further correlation function.

8. The receiver according to claim 2, further comprising:
means for calculating a phase shift parameter between the buffer signal and the reference signal according to the frequency-domain correlation function.

9. The receiver according to claim 1, wherein the at least one preamble signal is a single preamble signal.

10. The receiver according to claim 8, wherein the at least one preamble signal comprises a plurality of first preamble signals equal to each other and at least one second preamble signal different from the first preamble signals, the receiver further comprising:
means for discriminating each second preamble signal from the first preamble signals according to a comparison between the phase shift parameter of the second preamble signal and the phase shift parameter of the first preamble signals.

11. The receiver according to claim 1, wherein the receiver is an OFDM receiver.
